(19) United States
(12) Patent Application Publication
(10) Pub. No.: US 2025/0384828 A1
(43) Pub. Date: Dec. 18, 2025

(54) PIXEL CIRCUIT, DRIVING METHOD AND DISPLAY DEVICE

(71) Applicant: BOE TECHNOLOGY GROUP CO., LTD., Beijing (CN)

(72) Inventors: Li Wang, Beijing (CN); Yu Feng, Beijing (CN)

(73) Assignee: BOE TECHNOLOGY GROUP CO., LTD., Beijing (CN)

(21) Appl. No.: 18/881,885

(22) PCT Filed: Sep. 28, 2023
(86) PCT No.: PCT/CN2023/122522

§ 371 Date: Jan. 7, 2025

(30) Foreign Application Priority Data
Nov. 25, 2022 (CN) 202211492349.2

(51) Int. Cl. G09G 3/3233

(52) U.S. Cl. CPC G09G 3/3233; G09G 2300/0819; G09G 2300/0842; G09G 2300/0861; G09G 2310/08; G09G 2320/0247

(57) ABSTRACT

A pixel circuit, a driving method and a display device are provided. The pixel circuit includes a driving transistor and a control circuit; the control circuit is electrically connected to a gate electrode of the driving transistor. The control circuit is configured to, in a refreshing frame, in a first phase arranged before a data writing phase, control an absolute value of a difference between a potential of the gate electrode of the driving transistor and a potential of the electrode of the driving transistor to be less than a voltage difference threshold; the electrode comprises a first electrode of the driving transistor and/or a second electrode of the driving transistor.

### CROSS-REFERENCE TO RELATED APPLICATION

The present application claims a priority to the Chinese patent application No. 202211492349.2 filed in China on Nov. 25, 2022, a disclosure of which is incorporated herein by reference in its entirety.

### TECHNICAL FIELD

The present disclosure relates to the field of display technology, and in particular, to a pixel circuit, a driving method and a display device.

### BACKGROUND

Low frequency is conducive to reducing system power consumption and improving a display battery life. However, the low frequency is more prone to a flickering problem. A Low Temperature Polycrystalline Oxide (LTPO) technology utilizes the low leakage characteristics of an oxide-TFT (oxide thin film transistor) to effectively improve a voltage retention rate of a long frame period; through the high-frequency reset of an anode of an Organic Light-Emitting Diode (OLED), a low-frequency component is reduced, thereby decreasing the visibility of flicker to the human eye.

In a low-frequency driving mode, a display period can include a refreshing frame and at least one maintenance frame. In the refreshing frame, before the data is written, there is a strong bias process for a driving transistor in a pixel circuit, and there is no strong bias process in the maintenance frame, which leads to a low light-emitting current of the driving transistor in the refreshing frame, resulting in a difference between the brightness of the refreshing frame and the brightness of the maintenance frame, and leading to flickering.

### SUMMARY

In a first aspect, the embodiments of the present disclosure provide a pixel circuit, including a driving transistor and a control circuit;
the control circuit is electrically connected to a gate electrode of the driving transistor, and the control circuit is further electrically connected to an electrode of the driving transistor; the control circuit is configured to control, in a first phase of a refreshing frame, an absolute value of a difference between a potential of the gate electrode of the driving transistor and a potential of the electrode of the driving transistor to be less than a voltage difference threshold, wherein the first phase is arranged before a data writing phase;
the electrode includes a first electrode of the driving transistor and/or a second electrode of the driving transistor.

Optionally, a ratio of the voltage difference threshold to an absolute value of a threshold voltage of the driving transistor is greater than or equal to 0.8 and less than or equal to 1.2.

Optionally, the control circuit includes a reference voltage writing circuit, a compensation control circuit and an on-off control circuit;
the reference voltage writing circuit is electrically connected to each of a scanning line, a reference voltage end and the first electrode of the driving transistor, and is configured to write a reference voltage provided by the reference voltage end into the first electrode of the driving transistor under the control of a scanning signal provided by the scanning line;
the compensation control circuit is electrically connected to each of a compensation control line, the second electrode of the driving transistor and a control node, and is configured to control the second electrode of the driving transistor to be electrically connected to the control node under the control of a compensation control signal provided by the compensation control line;
the on-off control circuit is electrically connected to each of a first gate line, the gate electrode of the driving transistor and the control node, and is configured to control the gate electrode of the driving transistor to be electrically connected to the control node under the control of a first gate electrode driving signal provided by the first gate line.

Optionally, the control circuit includes a reference voltage writing circuit and an on-off control circuit;
the reference voltage writing circuit is electrically connected to each of a scanning line, a reference voltage end and the second electrode of the driving transistor, and is configured to write a reference voltage provided by the reference voltage end into the second electrode of the driving transistor under the control of a scanning signal provided by the scanning line;
the on-off control circuit is electrically connected to each of a first gate line, the gate electrode of the driving transistor and the second electrode of the driving transistor, and is configured to control the gate electrode of the driving transistor to be electrically connected to the second electrode of the driving transistor under the control of a first gate electrode driving signal provided by the first gate line.

Optionally, the reference voltage writing circuit includes a first transistor, the compensation control circuit includes a second transistor, and the on-off control circuit includes a third transistor;
a gate electrode of the first transistor is electrically connected to the scanning line, a first electrode of the first transistor is electrically connected to the reference voltage end, and a second electrode of the first transistor is electrically connected to the first electrode of the driving transistor;
a gate electrode of the second transistor is electrically connected to the compensation control line, a first electrode of the second transistor is electrically connected to the control node, and a second electrode of the second transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the control node.

Optionally, the second transistor is a p-type transistor; or, both the second transistor and the third transistor are n-type transistors, and the compensation control line and the first gate line are a same signal line.

Optionally, the reference voltage writing circuit includes a first transistor, and the on-off control circuit includes a third transistor;
a gate electrode of the first transistor is electrically connected to the scanning line, a first electrode of the first transistor is electrically connected to the reference voltage end, and a second electrode of the first transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the second electrode of the driving transistor.

Optionally, the pixel circuit according to at least one embodiment of the present disclosure, further including a light-emitting element, a first light-emitting control circuit, a second light-emitting control circuit, a data writing circuit and a first initialization circuit;
the first light-emitting control circuit is electrically connected to each of a light-emitting control line, a first voltage end, and the first electrode of the driving transistor, and is configured to control the first voltage end to be electrically connected to the first electrode of the driving transistor under the control of a light-emitting control signal on the light-emitting control line;
the second light-emitting control circuit is electrically connected to each of the light-emitting control line, the second electrode of the driving transistor and a first electrode of the light-emitting element, and is configured to control the second electrode of the driving transistor to be electrically connected to the first electrode of the light-emitting element under the control of the light-emitting control signal provided by the light-emitting control line; a second electrode of the light-emitting element is electrically connected to a second voltage end;
the data writing circuit is electrically connected to each of a second gate line, a data line, and the first electrode of the driving transistor, and is configured to write a data voltage provided by the data line into the first electrode of the driving transistor under the control of a second gate electrode driving signal provided by the second gate line;
the first initialization circuit is electrically connected to each of a reset line, a first initial voltage end and a control node, and is configured to write a first initial voltage provided by the first initial voltage end into the control node under the control of a reset signal provided by the reset line.

Optionally, the pixel circuit according to at least one embodiment of the present disclosure, further including an energy storage circuit;
the energy storage circuit is electrically connected to the gate electrode of the driving transistor, and is configured to maintain the potential of the gate electrode of the driving transistor.

Optionally, the pixel circuit according to at least one embodiment of the present disclosure, further including a second initialization circuit;
the second initialization circuit is electrically connected to each of a scanning line, a second initial voltage end and the first electrode of the light-emitting element, and is configured to write a second initial voltage provided by the second initial voltage end into the first electrode of the light-emitting element under the control of a scanning signal provided by the scanning line.

Optionally, the data writing circuit includes a fourth transistor, the first light-emitting control circuit includes a fifth transistor, the second light-emitting control circuit includes a sixth transistor, and the first initialization circuit includes a seventh transistor;
a gate electrode of the fourth transistor is electrically connected to the second gate line, a first electrode of the fourth transistor is electrically connected to the data line, and a second electrode of the fourth transistor is electrically connected to the first electrode of the driving transistor;
a gate electrode of the fifth transistor is electrically connected to the light-emitting control line, a first electrode of the fifth transistor is electrically connected to the first voltage end, and a second electrode of the fifth transistor is electrically connected to the first electrode of the driving transistor;
a gate electrode of the sixth transistor is electrically connected to the light-emitting control line, a first electrode of the sixth transistor is electrically connected to the second electrode of the driving transistor, and a second electrode of the sixth transistor is electrically connected to the first electrode of the light-emitting element;
a control electrode of the seventh transistor is electrically connected to the reset line, a first electrode of the seventh transistor is electrically connected to the first initial voltage end, and a second electrode of the seventh transistor is electrically connected to the control node.

Optionally, the energy storage circuit includes a storage capacitor, and the second initialization circuit includes an eighth transistor;
a first end of the storage capacitor is electrically connected to the gate electrode of the driving transistor, and a second end of the storage capacitor is electrically connected to the first voltage end;
a gate electrode of the eighth transistor is electrically connected to the scanning line, a first electrode of the eighth transistor is electrically connected to the second initial voltage end, and a second electrode of the eighth transistor is electrically connected to the first electrode of the light-emitting element.

In a second aspect, the embodiments of the present disclosure provide a driving method, applied to the above-mentioned pixel circuit, wherein a display period includes the refreshing frame; the refreshing frame includes the first phase arranged before the data writing phase; the driving method includes:
in the first phase of the refreshing frame, controlling, by the control circuit, the absolute value of the difference between the potential of the gate electrode of the driving transistor and the potential of the electrode of the driving transistor to be less than the voltage difference threshold; the electrode includes the first electrode of the driving transistor and/or the second electrode of the driving transistor.

Optionally, a ratio of the voltage difference threshold to an absolute value of a threshold voltage of the driving transistor is greater than or equal to 0.8 and less than or equal to 1.2.

Optionally, the control circuit includes a reference voltage writing circuit, a compensation control circuit and an on-off control circuit; the refreshing frame further includes a reset phase and the data writing phase arranged sequentially in that order after the first phase; the driving method includes:
in at least part of the first phase, the reset phase and at least part of the data writing phase, writing, by the reference voltage writing circuit, the reference voltage to the first electrode of the driving transistor under the control of a scanning signal, and controlling, by the compensation control circuit, the second electrode of the driving transistor to be electrically connected to a control node under the control of a compensation control signal; controlling, by the on-off control circuit, the gate electrode of the driving transistor to be electrically connected to the control node under the control of a first gate electrode driving signal, to cause the driving transistor to be in a diode connection state.

Optionally, the control circuit includes a reference voltage writing circuit and an on-off control circuit; the refreshing frame further includes a reset phase and the data writing phase arranged sequentially in that order after the first phase; the driving method includes:
in at least part of the first phase, the reset phase and at least part of the data writing phase, writing, by the reference voltage writing circuit, the reference voltage to the second electrode of the driving transistor under the control of a scanning signal; controlling, by the on-off control circuit, the gate electrode of the driving transistor to be electrically connected to the second electrode of the driving transistor under the control of a first gate electrode driving signal, to cause the driving transistor to be in a diode connection state.

Optionally, the refreshing frame further includes a first bias phase and a first light-emitting phase arranged after the data writing phase; the pixel circuit further includes a light-emitting element, a first initialization circuit, the data writing phase, a first light-emitting control circuit and a second light-emitting control circuit;
in at least part of the data writing phase, writing, by a data writing circuit, a data voltage on a data line into the first electrode of the driving transistor under the control of a second gate electrode driving signal;
in at least part of the reset phase, writing, by the first initialization circuit, a first initial voltage into the control node under the control of a reset signal;
in at least part of the first bias phase, writing, by the reference voltage writing circuit, the reference voltage into the first electrode of the driving transistor or the second electrode of the driving transistor under the control of the scanning signal;
in the first light-emitting phase, controlling, by the first light-emitting control circuit, a first voltage end to be electrically connected to the first electrode of the driving transistor under the control of a light-emitting control signal provided by a light-emitting control line, and controlling, by the second light-emitting control circuit, the second electrode of the driving transistor to be electrically connected to a first electrode of the light-emitting element under the control of the light-emitting control signal, and driving, by the driving transistor, the light-emitting element.

Optionally, the display period further includes a maintenance frame; the maintenance frame includes a second bias phase and a second light-emitting phase arranged sequentially in that order; the driving method includes:
in at least part of the second bias phase, writing, by the reference voltage writing circuit, the reference voltage into the first electrode of the driving transistor or the second electrode of the driving transistor under the control of the scanning signal;
in the second light-emitting phase, controlling, by a first light-emitting control circuit, a first voltage end to be electrically connected to the first electrode of the driving transistor under the control of a light-emitting control signal provided by a light-emitting control line, and controlling, by a second light-emitting control circuit, the second electrode of the driving transistor to be electrically connected to a first electrode of a light-emitting element under the control of the light-emitting control signal, and driving, by the driving transistor, the light-emitting element.

In a third aspect, the embodiments of the present disclosure further provide a display device, including the above-mentioned pixel circuit.

### BRIEF DESCRIPTION OF THE DRAWINGS

FIG. 1 is a structural diagram of a pixel circuit according to an embodiment of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a structural diagram of a pixel circuit according to at least one embodiment of the present disclosure;

FIG. 8 is a circuit diagram of a pixel circuit according to at least one embodiment of the present disclosure;

FIG. 9 is a timing diagram of the pixel circuit shown in FIG. 8 according to at least one embodiment of the present disclosure;

FIG. 10 is a circuit diagram of a pixel circuit according to at least one embodiment of the present disclosure;

FIG. 11 is a timing diagram of the pixel circuit shown in FIG. 10 according to at least one embodiment of the present disclosure;

FIG. 12 is a circuit diagram of a pixel circuit according to at least one embodiment of the present disclosure;

FIG. 13 is a timing diagram of a pixel circuit shown in FIG. 12 according to at least one embodiment of the present disclosure.

### DETAILED DESCRIPTION

The technical solutions in the embodiments of the present disclosure will be clearly and thoroughly described below with reference to the accompanying drawings in the embodiments of the present disclosure. Obviously, the described embodiments are only some of the embodiments of the present disclosure, not all of them. Based on the embodiments in the present disclosure, all other embodiments obtained by those of ordinary skill in the art without making creative efforts fall within the scope of the present disclosure.

A transistor used in all embodiments of the present disclosure may be a thin-film transistor or a field-effect transistor or other devices with a same characteristics. In the embodiments of the present disclosure, in order to distinguish the two electrodes of the transistor other than a gate electrode, one of the electrodes is called a first electrode and the other electrode is called a second electrode.

In practical operation, when the transistor is the thin-film transistor or the field-effect transistor, the first electrode may be a drain electrode and the second electrode may be a source electrode; or, the first electrode may be a source electrode and the second electrode may be a drain electrode.

The pixel circuit according to the embodiments of the present disclosure includes a driving transistor and a control circuit;
the control circuit is electrically connected to a gate electrode of the driving transistor, and the control circuit is further electrically connected to the electrode of the driving transistor; the control circuit is configured to control, in a first phase of a refreshing frame, an absolute value of a difference between a potential of the gate electrode of the driving transistor and a potential of the electrode of the driving transistor to be less than a voltage difference threshold, wherein the first phase is arranged before a data writing phase; the electrode includes a first electrode of the driving transistor and/or a second electrode of the driving transistor.

In the embodiment of the present disclosure, when the pixel circuit is in operation, in the refreshing frame, before the data writing phase, the driving transistor will not be strongly biased. This prevents the strong bias from affecting the characteristics of the driving transistor, which can effectively reduce or eliminate a phenomenon of uneven brightness caused by a difference between an operating state of the driving transistor in the refreshing frame and an operating state of the driving transistor in a maintenance frame, thereby inhibiting flicker. In at least one embodiment of the present disclosure, the voltage difference threshold can be selected based on an actual condition, for example, the voltage difference threshold can be selected based on an absolute value of a threshold voltage of the driving transistor.

Optionally, a ratio of the voltage difference threshold to an absolute value of a threshold voltage of the driving transistor is greater than or equal to 0.8 and less than or equal to 1.2, but the present disclosure is not limited thereto.

Optionally, when the threshold voltage of the driving transistor is greater than or equal to −3.5V and less than or equal to −2V, the voltage difference threshold may be greater than or equal to 1.8V and less than or equal to 4V, but the present disclosure is not limited thereto.

In the related art, when the driving transistor is a p-type transistor, in a first phase of a refreshing frame, a gate electrode potential of the driving transistor is reset to an initial voltage Vinit, and a source electrode potential of the driving transistor is reset to a reference voltage Vref, wherein the first phase is arranged before a data writing phase; a voltage value of the initial voltage Vinit may be greater than or equal to −5V and less than or equal to −3V, and a voltage value of the reference voltage Vref may be greater than or equal to 5V and less than or equal to 7V. Thus, in the first phase, a gate-source voltage of the driving transistor is greater than or equal to −12V and less than or equal to −8V, and in general, the threshold voltage of the driving transistor is greater than or equal to −3.5V and less than or equal to −2V. That is, in the first phase, the gate-source voltage of the driving transistor is much less than the threshold voltage of the driving transistor, and the driving transistor is in an on-bias state. In the first phase of the refreshing frame, the driving transistor is in a strong negative voltage bias state, causing significant negative drift of the threshold voltage of the driving transistor, while the maintenance frame does not include a phase that the driving transistor is in the strong negative voltage bias state, causing the light-emitting current of the driving transistor to be low in the refreshing frame, leading to a large difference between the light-emitting brightness of the light-emitting element in the refreshing frame and the light-emitting brightness of the light-emitting element in the maintenance frame, resulting in flickering. Based on this, in the embodiments of the present disclosure, in the refreshing frame, before the data writing phase, it controls a strong bias to be applied to the driving transistor. This prevents the influence of the strong bias on the characteristics of the driving transistor, and can effectively reduce or eliminate a phenomenon of uneven brightness caused by a difference between an operating state of the driving transistor in the refreshing frame and an operating state of the driving transistor in the maintenance frame, thereby inhibiting flicker.

As shown in FIG. 1, the pixel circuit according to the embodiments of the present disclosure includes a driving transistor DT and a control circuit 11;

the control circuit 11 is electrically connected to each of a gate electrode of the driving transistor DT, a first electrode of the driving transistor DT and a second electrode of the driving transistor DT; the control circuit is configured to control, in a first phase of a refreshing frame, an absolute value of a difference between potential of the gate electrode of the driving transistor DT and potential of the first electrode of the driving transistor DT to be less than a voltage difference threshold, to control an absolute value of a difference between potential of the gate electrode of the driving transistor DT and potential of the second electrode of the driving transistor DT to be less than a voltage difference threshold, wherein the first phase is arranged before a data writing phase.

In the embodiment shown in FIG. 1, the driving transistor DT is a p-type transistor, but the present disclosure is not limited thereto; in practical operation, the driving transistor DT may alternatively be an n-type transistor.

In at least one embodiment of the present disclosure, the control circuit includes a reference voltage writing circuit, a compensation control circuit and an on-off control circuit;
the reference voltage writing circuit is electrically connected to each of the scanning line, the reference voltage end and the first electrode of the driving transistor, and is configured to write a reference voltage provided by the reference voltage end into the first electrode of the driving transistor under the control of a scanning signal provided by the scanning line;
the compensation control circuit is electrically connected to each of the compensation control line, the second electrode of the driving transistor and a control node, and is configured to control the second electrode of the driving transistor to be electrically connected to the control node under the control of a compensation control signal provided by the compensation control line;
the on-off control circuit is electrically connected to each of the first gate line, the gate electrode of the driving transistor and the control node, and is configured to control the gate electrode of the driving transistor to be electrically connected to the control node under the control of a first gate electrode driving signal provided by the first gate line.

In a specific implementation, the control circuit may include a reference voltage writing circuit, a compensation control circuit and an on-off control circuit, and the refreshing frame further includes a reset phase and a data writing phase arranged sequentially in that order after the first phase;
in at least part of the first phase, the reset phase and at least part of the data writing phase, the reference voltage writing circuit writes the reference voltage into the first electrode of the driving transistor under the control of a scanning signal, and the compensation control circuit controls the second electrode of the driving transistor to be electrically connected to a control node under the control of a compensation control signal; the on-off control circuit controls the gate electrode of the driving transistor to be electrically connected to the control node under the control of a first gate electrode driving signal, to cause the driving transistor to be in a diode connection state. At this time, a gate-source voltage of the driving transistor is Vth, and an absolute value of the gate-source voltage of the driving transistor is less than the voltage difference threshold, wherein Vth is a threshold voltage of the driving transistor.

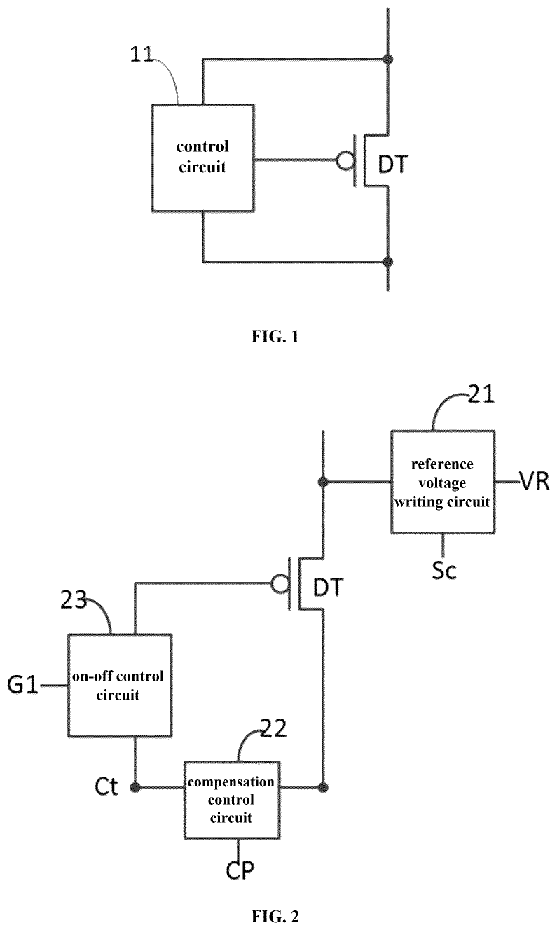

As shown in FIG. 2, based on the embodiment of the pixel circuit shown in FIG. 1, the control circuit includes a reference voltage writing circuit 21, a compensation control circuit 22 and an on-off control circuit 23;
the reference voltage writing circuit 21 is electrically connected to each of the scanning line Sc, the reference voltage end VR and the first electrode of the driving transistor DT, and is configured to write a reference voltage Vref provided by the reference voltage end VR into the first electrode of the driving transistor DT under the control of a scanning signal provided by the scanning line Sc;
the compensation control circuit 22 is electrically connected to each of the compensation control line CP, the second electrode of the driving transistor DT and the control node Ct, and is configured to control the second electrode of the driving transistor DT to be electrically connected to the control node Ct under the control of a compensation control signal provided by the compensation control line CP;
the on-off control circuit 23 is electrically connected to each of the first gate line G1, the gate electrode of the driving transistor DT and the control node Ct, and is configured to control the gate electrode of the driving transistor DT to be electrically connected to the control node Ct under the control of a first gate electrode driving signal provided by the first gate line G1.

In at least one embodiment, when the pixel circuit shown in FIG. 2 of the present disclosure is in operation, the refreshing frame further includes a reset phase and a data writing phase arranged sequentially in that order after the first phase;
in at least part of the first phase, the reset phase and at least part of the data writing phase, the reference voltage writing circuit 21 writes the reference voltage Vref into the first electrode of the driving transistor DT under the control of the scanning signal, and the compensation control circuit 22 controls the second electrode of the driving transistor DT to be electrically connected to the control node Ct under the control of the compensation control signal; the on-off control circuit 23 controls the gate electrode of the driving transistor DT to be electrically connected to the control node Ct under the control of the first gate electrode driving signal, to cause driving transistor DT to be in a diode connection state. At this time, a gate-source voltage of the driving transistor DT is Vth, and Vth is a threshold voltage of the driving transistor DT.

In at least one embodiment of the present disclosure, the control circuit includes a reference voltage writing circuit and an on-off control circuit;
the reference voltage writing circuit is electrically connected to each of the scanning line, the reference voltage end and the second electrode of the driving transistor, and is configured to write the reference voltage provided by the reference voltage end into the second electrode of the driving transistor under the control of the scanning signal provided by the scanning line;
the on-off control circuit is electrically connected to each of the first gate line, the gate electrode of the driving transistor and the second electrode of the driving transistor, and is configured to control the gate electrode of the driving transistor to be electrically connected to the second electrode of the driving transistor under the control of the first gate electrode driving signal provided by the first gate line.

In a specific implementation, the control circuit may include a reference voltage writing circuit and an on-off control circuit; the refreshing frame further includes a reset phase and a data writing phase arranged sequentially in that order after the first phase;
in at least part of the first phase, the reset phase and at least part of the data writing phase, the reference voltage writing circuit writes the reference voltage into the second electrode of the driving transistor under the control of the scanning signal; the on-off control circuit controls the gate electrode of the driving transistor to be electrically connected to the second electrode of the driving transistor under the control of the first gate electrode driving signal, to cause the driving transistor to be in a diode connection state. At this time, the gate-source voltage of the driving transistor is Vth, and an absolute value of the gate-source voltage of the driving transistor is less than a voltage difference threshold, wherein Vth is the threshold voltage of the driving transistor.

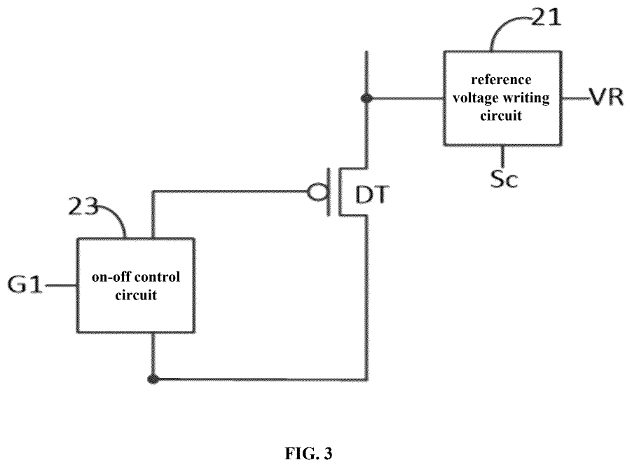

As shown in FIG. 3, based on the embodiment of the pixel circuit shown in FIG. 1, the control circuit includes a reference voltage writing circuit 21 and an on-off control circuit 23;
the reference voltage writing circuit 21 is electrically connected to each of the scanning line Sc, the reference voltage end VR and the second electrode of the driving transistor DT, and is configured to write the reference voltage Vref provided by the reference voltage end VR into the second electrode of the driving transistor DT under the control of the scanning signal provided by the scanning line Sc;
the on-off control circuit 23 is electrically connected to each of the first gate line G1, the gate electrode of the driving transistor DT and the second electrode of the driving transistor DT, and is configured to control the gate electrode of the driving transistor DT to be electrically connected to the second electrode of the driving transistor DT under the control of the first gate electrode driving signal provided by the first gate line G1.

In at least one embodiment, the pixel circuit shown in FIG. 3 of the present disclosure is in operation, the refreshing frame further includes a reset phase and a data writing phase arranged sequentially in that order after the first phase;
in at least part of the first phase, the reset phase and at least part of the data writing phase, the reference voltage writing circuit 21 writes the reference voltage Vref into the second electrode of the driving transistor DT under the control of the scanning signal; the on-off control circuit 23 controls the gate electrode of the driving transistor DT to be electrically connected to the second electrode of the driving transistor DT under the control of the first gate electrode driving signal, to cause the driving transistor DT to be in a diode connection state.

Optionally, the reference voltage writing circuit includes a first transistor, the compensation control circuit includes a second transistor, and the on-off control circuit includes a third transistor;
a gate electrode of the first transistor is electrically connected to the scanning line, a first electrode of the first transistor is electrically connected to the reference voltage end, and a second electrode of the first transistor is electrically connected to the first electrode of the driving transistor;
a gate electrode of the second transistor is electrically connected to the compensation control line, a first electrode of the second transistor is electrically connected to the control node, and a second electrode of the second transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the control node.

In at least one embodiment of the present disclosure, the second transistor is a p-type transistor; or, both the second transistor and the third transistor are n-type transistors, and the compensation control line and the first gate line are a same signal line.

Optionally, the reference voltage writing circuit includes a first transistor, and the on-off control circuit includes a third transistor;
a gate electrode of the first transistor is electrically connected to the scanning line, a first electrode of the first transistor is electrically connected to the reference voltage end, and a second electrode of the first transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the second electrode of the driving transistor.

In at least one embodiment of the present disclosure, the pixel circuit may further include a light-emitting element, a first light-emitting control circuit, a second light-emitting control circuit, a data writing circuit and a first initialization circuit;
the first light-emitting control circuit is electrically connected to each of a light-emitting control line, a first voltage end, and the first electrode of the driving transistor, and is configured to control the first voltage end to be electrically connected to the first electrode of the driving transistor under the control of a light-emitting control signal on the light-emitting control line;
the second light-emitting control circuit is electrically connected to each of the light-emitting control line, the second electrode of the driving transistor and a first electrode of the light-emitting element, and is configured to control the second electrode of the driving transistor to be electrically connected to the first electrode of the light-emitting element under the control of the light-emitting control signal provided by the light-emitting control line; a second electrode of the light-emitting element is electrically connected to a second voltage end;
the data writing circuit is electrically connected to each of a second gate line, a data line, and the first electrode of the driving transistor, and is configured to write a data voltage provided by the data line into the first electrode of the driving transistor under the control of a second gate electrode driving signal provided by the second gate line;
the first initialization circuit is electrically connected to each of a reset line, a first initial voltage end and a control node, and is configured to write a first initial voltage provided by the first initial voltage end into the control node under the control of a reset signal provided by the reset line.

In a specific implementation, the pixel circuit may further include a light-emitting element, a first light-emitting control circuit, a second light-emitting control circuit, a data writing circuit and a first initialization circuit; the first light-emitting control circuit controls the first voltage end to be electrically connected to the first electrode of the driving transistor under the control of the light-emitting control signal, the second light-emitting control circuit controls the second electrode of the driving transistor to be electrically connected to the first electrode of the light-emitting element under the control of the light-emitting control signal, the data writing circuit writes the data voltage into the first electrode of the driving transistor under the control of the second gate electrode driving signal, and the first initialization circuit writes the first initial voltage into the control node under the control of the reset signal.

In at least one embodiment of the present disclosure, the first voltage end may be a power voltage end, and the second voltage end may be a low voltage end.

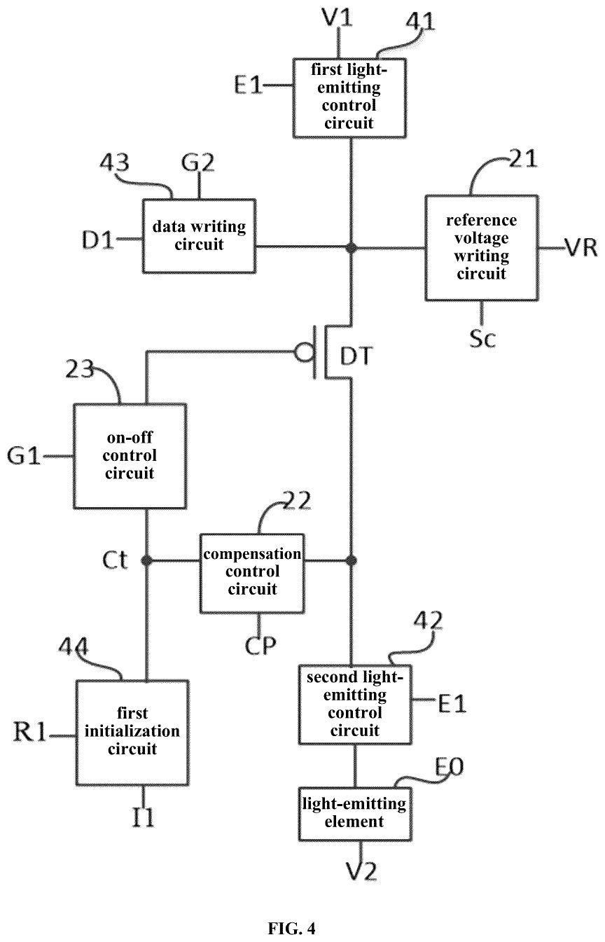

As shown in FIG. 4, based on at least one embodiment of the pixel circuit shown in FIG. 2, the pixel circuit may further include a light-emitting element E0, a first light-emitting control circuit 41, a second light-emitting control circuit 42, a data writing circuit 43, and a first initialization circuit 44;
the first light-emitting control circuit 41 is electrically connected to each of the light-emitting control line E1, the first voltage end V1, and the first electrode of the driving transistor DT, and is configured to control the first voltage end V1 to be electrically connected to the first electrode of the driving transistor under the control of the light-emitting control signal on the light-emitting control line E1;
the second light-emitting control circuit 42 is electrically connected to each of the light-emitting control line E1, the second electrode of the driving transistor DT, and the first electrode of the light-emitting element E0, and is configured to control the second electrode of the driving transistor DT to be electrically connected to the first electrode of the light emitting element E0 under the control of the light-emitting control signal provided by the light-emitting control line E1, and is configured to control the second electrode of the driving transistor DT to be electrically connected to the first electrode of the light-emitting element E0; the second electrode of the light-emitting element E0 is electrically connected to the second voltage end V2;

the data writing circuit 43 is electrically connected to each of the second gate line G2, the data line D1 and the first electrode of the driving transistor DT, and is configured to write the data voltage Vdata provided by the data line D1 into the first electrode of the driving transistor DT under the control of the second gate electrode driving signal provided by the second gate line G2;

the first initialization circuit 44 is electrically connected to each of the reset line R1, the first initial voltage end I1 and the control node Ct, and is configured to write the first initial voltage Vinit1 provided by the first initial voltage end I1 into the control node Ct under the control of the reset signal provided by the reset line R1.

In at least one embodiment, when the pixel circuit shown in FIG. 4 of the present disclosure is in operation, the refreshing frame further includes a first bias phase and a first light-emitting phase arranged after the data writing phase; the display period further includes a maintenance frame; the maintenance frame includes a second bias phase and a second light-emitting phase arranged sequentially in that order;
in at least part of the data writing phase, the data writing circuit 43 writes the data voltage Vdata on the data line D1 into the first electrode of the driving transistor DT under the control of the second gate electrode driving signal;
in at least part of the reset phase, the first initialization circuit 44 writes the first initial voltage Vinit1 into the control node Ct under the control of the reset signal;
in at least part of the first bias phase, the reference voltage writing circuit 21 writes the reference voltage Vref into the first electrode of the driving transistor DT under the control of the scanning signal;
in the first light-emitting phase, the first light-emitting control circuit 41 controls the first voltage end V1 to be electrically connected to the first electrode of the driving transistor DT under the control of the light-emitting control signal provided by the light-emitting control line E1, and the second light-emitting control circuit 42 controls the second electrode of the driving transistor DT to be electrically connected to the first electrode of the light-emitting element E0 under the control of the light-emitting control signal, and the driving transistor DT drives the light-emitting element E0;
in at least part of the second bias phase, the reference voltage writing circuit 21 writes the reference voltage Vref into the first electrode of the driving transistor DT under the control of the scanning signal;
in the second light-emitting phase, the first light-emitting control circuit 41 controls the first voltage end V1 to be electrically connected to the first electrode of the driving transistor DT under the control of the light-emitting control signal provided by the light-emitting control line E1, and the second light-emitting control circuit 42 controls the second electrode of the driving transistor DT to be electrically connected to the first electrode of the light-emitting element E0 under the control of the light-emitting control signal, and the driving transistor DT drives the light-emitting element E0.

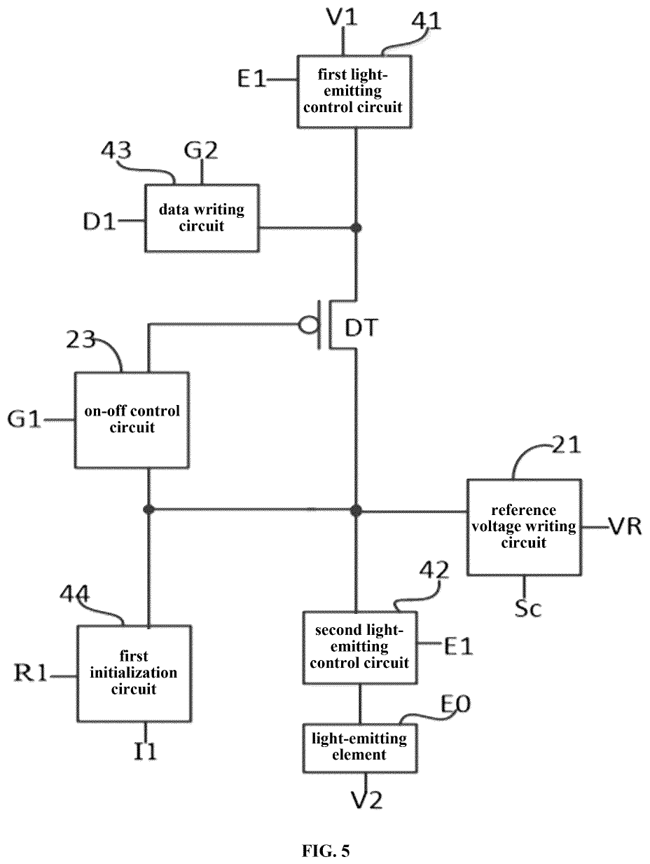

As shown in FIG. 5, based on at least one embodiment of the pixel circuit shown in FIG. 3, the pixel circuit may further include a light-emitting element E0, a first light-emitting control circuit 41, a second light-emitting control circuit 42, a data writing circuit 43 and a first initialization circuit 44;
the first light-emitting control circuit 41 is electrically connected to each of the light-emitting control line E1, the first voltage end V1 and the first electrode of the driving transistor DT, and is configured to control the first voltage end V1 to be electrically connected to the first electrode of the driving transistor under the control of the light-emitting control signal on the light-emitting control line E1;
the second light-emitting control circuit 42 is electrically connected to each of the light-emitting control line E1, the second electrode of the driving transistor DT and the first electrode of the light-emitting element E0, and is configured to control the second electrode of the driving transistor DT to be electrically connected to the first electrode of the light-emitting element E0 under the control of the light emitting control signal provided by the light emitting control line E1; the second electrode of the light-emitting element E0 is electrically connected to the second voltage end V2;
the data writing circuit 43 is electrically connected to each of the second gate line G2, the data line D1 and the first electrode of the driving transistor DT, and is configured to write the data voltage Vdata provided by the data line D1 into the first electrode of the driving transistor DT under the control of the second gate electrode driving signal provided by the second gate line G2;
the first initialization circuit 44 is electrically connected to each of the reset line R1, the first initial voltage end I1 and the control node Ct, and is configured to write the first initial voltage Vinit1 provided by the first initial voltage end I1 into the control node Ct under the control of the reset signal provided by the reset line R1.

In at least one embodiment, when the pixel circuit shown in FIG. 5 of the present disclosure is in operation, the refreshing frame further includes a first bias phase and a first light-emitting phase arranged after the data writing phase; the display period further includes a maintenance frame; the maintenance frame includes a second bias phase and a second light-emitting phase arranged sequentially in that order;
in at least part of the data writing phase, the data writing circuit 43 writes the data voltage Vdata on the data line D1 into the first electrode of the driving transistor DT under the control of the second gate electrode driving signal;
in at least part of the reset phase, the first initialization circuit 44 writes the first initial voltage Vinit1 into the control node Ct under the control of the reset signal;

in at least part of the first bias phase, the reference voltage writing circuit 21 writes the reference voltage Vref into the second electrode of the driving transistor DT under the control of the scanning signal;

in the first light-emitting phase, the first light-emitting control circuit 41 controls the first voltage end V1 to be electrically connected to the first electrode of the driving transistor DT under the control of the light-emitting control signal provided by the light-emitting control line E1, and the second light-emitting control circuit 42 controls the second electrode of the driving transistor DT to be electrically connected to the first electrode of the light-emitting element E0 under the control of the light-emitting control signal, and the driving transistor DT drives the light-emitting element E0;
in at least part of the second bias phase, the reference voltage writing circuit 21 writes the reference voltage Vref into the second electrode of the driving transistor DT under the control of the scanning signal;
in the second light-emitting phase, the first light-emitting control circuit 41 controls the first voltage end V1 to be electrically connected to the first electrode of the driving transistor DT under the control of the light-emitting control signal provided by the light-emitting control line E1, and the second light-emitting control circuit 42 controls the second electrode of the driving transistor DT to be electrically connected to the first electrode of the light-emitting element E0 under the control of the light-emitting control signal, and the driving transistor DT drives the light-emitting element E0.

The pixel circuit according to at least one embodiment of the present disclosure may further include an energy storage circuit;
the energy storage circuit is electrically connected to the gate electrode of the driving transistor, and is configured to maintain the potential of the gate electrode of the driving transistor.

Optionally, the pixel circuit according to at least one embodiment of the present disclosure further includes a second initialization circuit;
the second initialization circuit is electrically connected to each of the scanning line, the second initial voltage end and the first electrode of the light-emitting element, and is configured to write the second initial voltage provided by the second initial voltage end into the first electrode of the light-emitting element under the control of the scanning signal provided by the scanning line, so as to clear a residual charge of the first electrode of the light-emitting element.

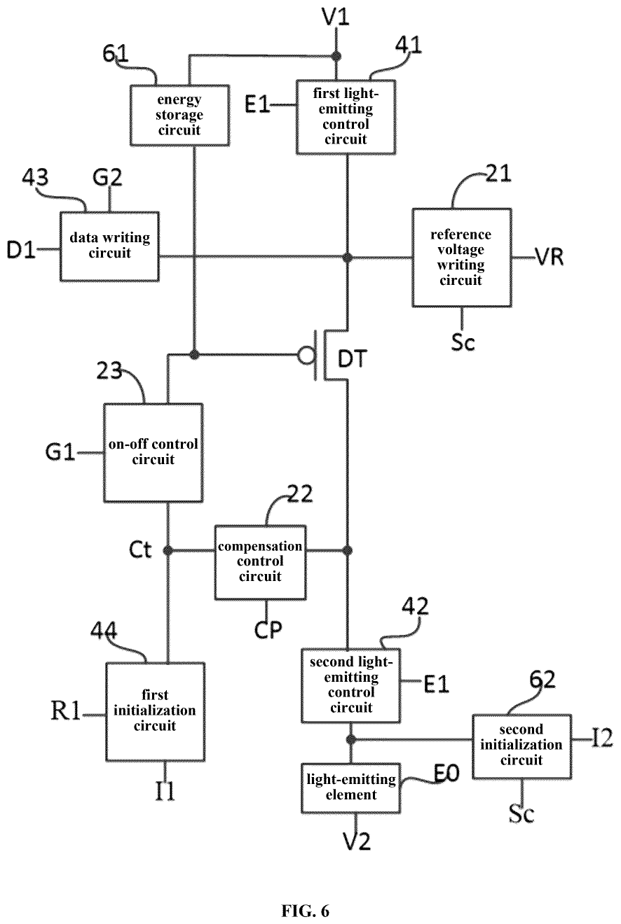

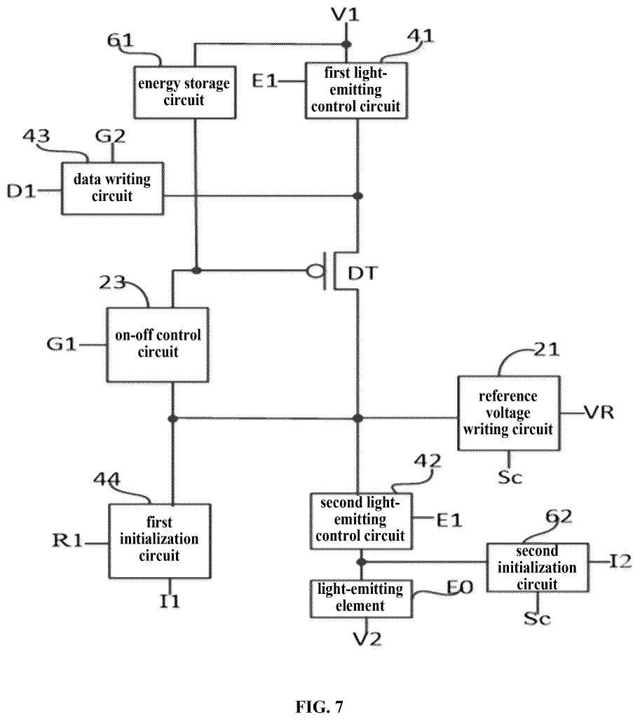

As shown in FIG. 6, based on at least one embodiment of the pixel circuit shown in FIG. 4, the pixel circuit according to at least one embodiment of the present disclosure further includes an energy storage circuit 61 and a second initialization circuit 62;
the energy storage circuit 61 is electrically connected to the gate electrode of the driving transistor DT, and is configured to maintain the potential of the gate electrode of the driving transistor DT;
the second initialization circuit 62 is electrically connected to each of the scanning line Sc, the second initial voltage end I2 and the first electrode of the light-emitting element E0, and is configured to write the second initial voltage Vinit2 provided by the second initial voltage end I2 into the first electrode of the light-emitting element E0 under the control of the scanning signal provided by the scanning line Sc, so as to clear the residual charge of the first electrode of the light-emitting element E0.

As shown in FIG. 7, based on at least one embodiment of the pixel circuit shown in FIG. 5, the pixel circuit according to at least one embodiment of the present disclosure further includes an energy storage circuit 61 and a second initialization circuit 62;
the energy storage circuit 61 is electrically connected to the gate electrode of the driving transistor DT, and is configured to maintain the potential of the gate electrode of the driving transistor DT;
the second initialization circuit 62 is electrically connected to each of the scanning line Sc, the second initial voltage end I2 and the first electrode of the light-emitting element E0, and is configured to write the second initial voltage Vinit2 provided by the second initial voltage end I2 into the first electrode of the light-emitting element E0 under the control of the scanning signal provided by the scanning line Sc, so as to clear the residual charge of the first electrode of the light-emitting element E0.

Optionally, the data writing circuit includes a fourth transistor, the first light-emitting control circuit includes a fifth transistor, the second light-emitting control circuit includes a sixth transistor, and the first initialization circuit includes a seventh transistor;
a gate electrode of the fourth transistor is electrically connected to the second gate line, a first electrode of the fourth transistor is electrically connected to the data line, and a second electrode of the fourth transistor is electrically connected to the first electrode of the driving transistor;
a gate electrode of the fifth transistor is electrically connected to the light-emitting control line, a first electrode of the fifth transistor is electrically connected to the first voltage end, and a second electrode of the fifth transistor is electrically connected to the first electrode of the driving transistor;
a gate electrode of the sixth transistor is electrically connected to the light-emitting control line, a first electrode of the sixth transistor is electrically connected to the second electrode of the driving transistor, and a second electrode of the sixth transistor is electrically connected to the first electrode of the light-emitting element;
a control electrode of the seventh transistor is electrically connected to the reset line, a first electrode of the seventh transistor is electrically connected to the first initial voltage end, and a second electrode of the seventh transistor is electrically connected to the control node.

Optionally, the energy storage circuit includes a storage capacitor, and the second initialization circuit includes an eighth transistor;
a first end of the storage capacitor is electrically connected to the gate electrode of the driving transistor, and a second end of the storage capacitor is electrically connected to the first voltage end;
a gate electrode of the eighth transistor is electrically connected to the scanning line, a first electrode of the eighth transistor is electrically connected to the second initial voltage end, and a second electrode of the eighth transistor is electrically connected to the first electrode of the light-emitting element.

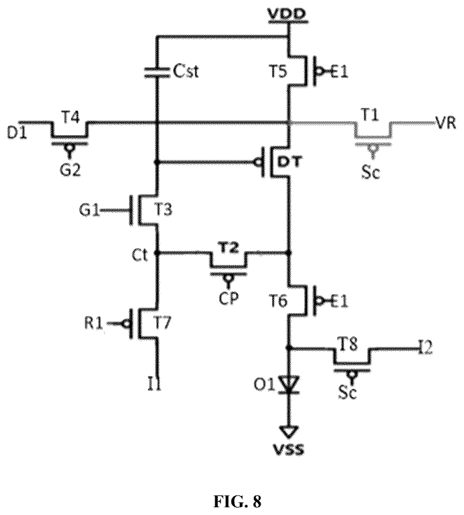

As shown in FIG. 8, based on at least one embodiment of the pixel circuit shown in FIG. 6, the reference voltage writing circuit includes a first transistor T1, the compensation control circuit includes a second transistor T2, and the on-off control circuit includes a third transistor T3; the light-emitting element is an organic light-emitting diode O1;
a gate electrode of the first transistor T1 is electrically connected to the scanning line Sc, a source electrode of the first transistor T1 is electrically connected to the reference voltage end VR, and a drain electrode of the first transistor T1 is electrically connected to a source electrode of the driving transistor DT;
a gate electrode of the second transistor T2 is electrically connected to the compensation control line CP, and a source electrode of the second transistor T2 is electrically connected to the control node Ct, and a drain electrode of the second transistor T2 is electrically connected to a drain electrode of the driving transistor DT;
a gate electrode of the third transistor T3 is electrically connected to the first gate line G1, a source electrode of the third transistor T3 is electrically connected to the gate electrode of the driving transistor DT, and a drain electrode of the third transistor T3 is electrically connected to the control node Ct;
the data writing circuit includes a fourth transistor T4, the first light-emitting control circuit includes a fifth transistor T5, the second light-emitting control circuit includes a sixth transistor T6, and the first initialization circuit includes a seventh transistor T7;
a gate electrode of the fourth transistor T4 is electrically connected to the second gate line G2, a source electrode of the fourth transistor T4 is electrically connected to the data line D1, and a drain electrode of the fourth transistor T4 is electrically connected to the source electrode of the driving transistor DT;
a gate electrode of the fifth transistor T5 is electrically connected to the light-emitting control line E1, a source electrode of the fifth transistor T5 is electrically connected to the power voltage end VDD, and a drain electrode of the fifth transistor T5 is electrically connected to the source electrode of the driving transistor DT;
a gate electrode of the sixth transistor T6 is electrically connected to the light-emitting control line E1, a source electrode of the sixth transistor T6 is electrically connected to the drain electrode of the driving transistor DT, and a drain electrode of the sixth transistor T6 is electrically connected to an anode of the organic light-emitting diode O1; a cathode of the O1 is electrically connected to a low voltage end VSS;
a gate electrode of the seventh transistor T7 is electrically connected to the reset line R1, a source electrode of the seventh transistor T7 is electrically connected to the first initial voltage end I1, and a drain electrode of the seventh transistor T7 is electrically connected to the control node Ct;
the energy storage circuit includes a storage capacitor Cst, and the second initialization circuit includes an eighth transistor T8;
a first end of the storage capacitor Cst is electrically connected to the gate electrode of the driving transistor DT, and a second end of the storage capacitor Cst is electrically connected to the power voltage end VDD;
the gate electrode of the eighth transistor T8 is electrically connected to the scanning line Sc, the source electrode of the eighth transistor T8 is electrically connected to the second initial voltage end I2, and the drain electrode of the eighth transistor T8 is electrically connected to the anode of the organic light-emitting diode O1.

In at least one embodiment of the pixel circuit shown in FIG. 8, T3 is an n-type transistor, and T1, T2, T4, T5, T6, T7, T8 and DT are all p-type transistors.

In at least one embodiment of the pixel circuit shown in FIG. 8, T3 is an oxide thin-film transistor, while the other transistors may be Low-Temperature Polycrystalline Silicon (LTPS) transistors, but the present disclosure is not limited thereto.

In at least one embodiment, when the pixel circuit shown in FIG. 8 of the present disclosure is in operation, the gate electrode of the T7 and the gate electrode of the T1 are controlled separately, the gate electrode of the T7 and the gate electrode of the T8 are controlled separately, and the gate electrode of the T2 and the gate electrode of the T4 are controlled separately.

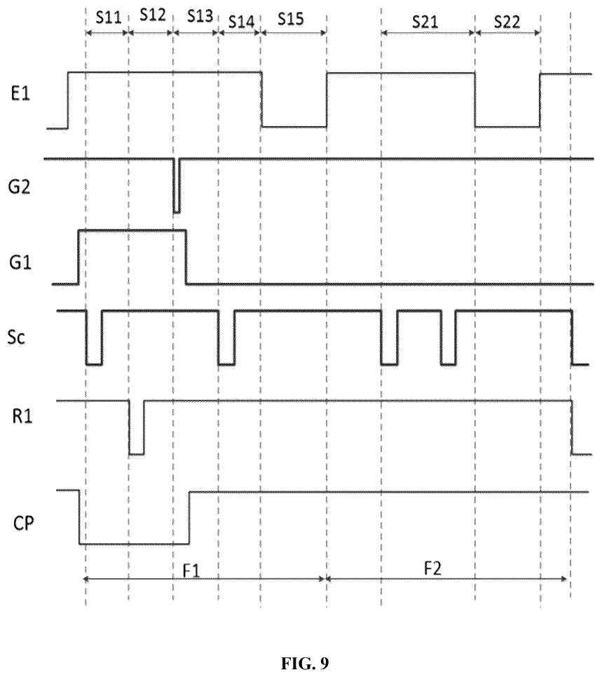

In at least one embodiment, when the pixel circuit shown in FIG. 8 of the present disclosure is in operation, as shown in FIG. 9, the display period may include a refreshing frame F1 and a maintenance frame F2;
as shown in FIG. 9, the refreshing frame includes a first phase S11, a reset phase S12, a data writing phase S13, a first bias phase S14 and a first light-emitting phase S15 arranged sequentially in that order; the maintenance frame includes a second bias phase S21 and a second light-emitting phase S22 arranged sequentially in that order;
in a first time period included in the first phase S11, the Sc provides a low voltage signal, the T1 is turned on, to write the reference voltage Vref into the source electrode of the DT;
in the first phase S11, the E1 provides a high voltage signal, the G2 provides a high voltage signal, the G1 provides a high voltage signal, the CP provides a low voltage signal, the R1 provides a high voltage signal, the T2 is turned on, the T3 is turned on, and the gate electrode of the driving transistor DT is electrically connected to the drain electrode of the driving transistor DT; the source electrode potential of the DT is Vref;
in the first phase S11, the DT is in a diode connection mode, the gate-source voltage Vgs of the DT is equal to Vth, the DT is in an off-bias state, and Vth is the threshold voltage of the DT;
in a second time period included in the reset phase S12, the R1 provides a low voltage signal, the T7 is turned on, to write the first initial voltage Vinit1 on the I1 into the control node Ct;
in the reset phase S12, the E1 provides a high voltage signal, the G2 provides a high voltage signal, the G1 provides a high voltage signal, the Sc provides a high voltage signal, the CP provides a low voltage signal, the T2 and the T3 are both turned on, to write Vinit1 into the gate electrode of the DT, so that the DT can be turned on at the beginning of the data writing phase S13; and in the reset phase S12, the gate electrode of the DT is electrically connected to the drain electrode of the DT, and the DT is in the diode connection mode, the gate-source voltage Vgs of the DT is equal to Vth, and the DT is in the off-bias state;

in a third time period included in the data writing phase S13, the G2 provides a low voltage signal, to write the data voltage Vdata on the data line D1 into the source electrode of the driving transistor DT;

in a fourth time period included in the data writing phase S13, the G1 provides a high voltage signal, the T3 is turned on, the CP provides a low voltage signal, and the T2 is turned on, to control the gate electrode of the DT to be electrically connected to the drain electrode of DT, and to control the DT to be in the diode connection mode, and the gate-source voltage Vgs of the DT is equal to Vth, the gate electrode potential of the DT is Vdata+Vth, and DT is in the off-bias state;
in the data writing phase S13, the E1 provides a high voltage signal, the Sc provides a high voltage signal, the T5 and the T6 are turned off, T1 is turned off, and T8 is turned off;
in a fifth time period included in the first bias phase S14, the Sc provides a low voltage signal, the T1 is turned on, to write the reference voltage Vref into the source electrode of the DT, and the T8 is turned on, to write the second initial voltage Vinit2 on the 12 to the anode of the O1 to clear the residual charge on the anode of the O1;
in the first bias phase S14, the E1 provides a high voltage signal, the G2 provides a high voltage signal, the G1 provides a low voltage signal, the R1 provides a high voltage signal, the CP provides a high voltage signal, the T5 and the T6 are turned off, the T1 is turned off, the T8 is turned off; the T2 is turned off, the T7 is turned off, and the gate electrode potential of the DT is maintained at Vdata+Vth;
in the first bias phase S14, the gate-source voltage Vgs of the DT is equal to Vdata+Vth−Vref, and the first bias phase S14 is a negative voltage bias phase;

in the first light-emitting phase S15, the E1 provides a low voltage signal, the G2 provides a high voltage signal, and the G1 provides a low voltage signal, the Sc provides a high voltage signal, the R1 provides a high voltage signal, the CP provides a high voltage signal, the T5 and the T6 are turned on, and the DT drives the O1 to emit light;
in sixth and seventh time periods included in the second bias phase S21, the Sc provides a low voltage signal, the T1 and the T8 are turned on to write the reference voltage Vref into the source electrode of the DT and write the second initial voltage Vinit2 into the anode of the O1;
in the second bias phase S21, the E1 provides a high voltage signal, the G2 provides a high voltage signal, the G1 provides a low voltage signal, the R1 provides a high voltage signal, and the CP provides a high voltage signal; the T5 and the T6 are turned off, the T1 is turned off, the T8 is turned off; the T2 is turned off, the T7 is turned off, and the gate electrode potential of the DT is maintained at Vdata+Vth;
in the second bias phase S21, the gate-source voltage Vgs of the DT is equal to Vdata+Vth−Vref, and the second bias phase S21 is a negative voltage bias phase;
in the second light-emitting phase S22, the E1 provides a low voltage signal, the G2 provides a high voltage signal, the G1 provides a low voltage signal, the Sc provides a high voltage signal, the R1 provides a high voltage signal, the CP provides a high voltage signal, the T5 and the T6 are turned on, and the DT drives the O1 to emit light.

In at least one embodiment, when the pixel circuit shown in FIG. 8 of the present disclosure is in operation,
in the first phase S11, the reset phase S12 and the data writing phase S13 included in the refreshing frame, the DT is in an off-bias state. However, since the gate-source voltage of the DT is Vth, the threshold voltage drift of the DT is small in the S11, the S12 and the S13, and the DT is not in a strong bias state;
in the first bias phase S14 included in the refreshing frame, the gate-source voltage Vgs of the DT is equal to Vdata+Vth−Vref, and the first bias phase S14 is a negative voltage bias phase;
in the second bias phase S21 included in the maintenance frame, the gate-source voltage Vgs of the DT is equal to Vdata+Vth−Vref, and the second bias phase S21 is a negative voltage bias phase.

In at least one embodiment, when the pixel circuit shown in FIG. 8 of the present disclosure is in operation, in the refreshing frame, before the data writing phase, there is no strong bias process applied to the driving transistor DT, and in the first bias phase S14 included in the refreshing frame and the second bias phase S21 included in the maintenance frame, a negative voltage bias is applied to the driving transistor DT. By arranging the bias voltage and bias time in the refreshing frame and the maintenance frame, the bias state of the driving transistor DT in the refreshing frame and the bias state of the driving transistor DT in the maintenance frame can be similar, and the threshold voltage of the driving transistor DT is roughly consistent, thereby ensuring that there is no significant difference in the light-emitting brightness of the O1 in the refreshing frame and the light-emitting brightness of the O1 in the maintenance frame, and there is no visual flicker.

In at least one embodiment of the pixel circuit shown in FIG. 8 of the present disclosure, six control signal lines are included, that are, a light-emitting control line E1, a first gate line G1, a second gate line G2, a scanning line Sc, a reset line R1, and a compensation control line CP, wherein a compensation control signal provided by the CP and a first gate electrode driving signal provided by the G1 are mutually inverted, and the compensation control signal and the first gate electrode driving signal can be output by a set of GOA (Gate On Array, a gate electrode drive circuit arranged on an array substrate) by adding an inverter structure.

Before data is written into the pixel circuit according to at least one embodiment of the present disclosure, the driving transistor is in an off-bias state, which can eliminate an influence of a grayscale voltage of a previous frame on the brightness of a current frame.

In at least one embodiment of the present disclosure, Vinit1 can be greater than or equal to −5V and less than or equal to −3, Vinit2 can be greater than or equal to −4V and less than or equal to −1V, and Vref can be greater than or equal to 5V and less than or equal to 8V, but the present disclosure is not limited thereto.

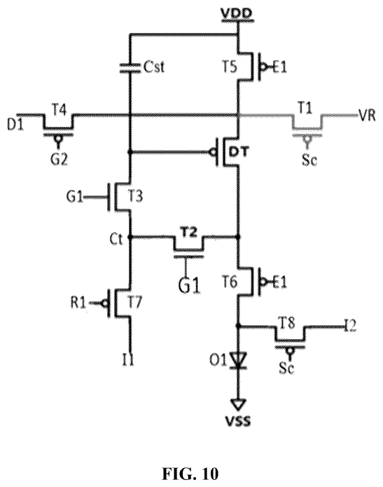

As shown in FIG. 10, based on at least one embodiment of the pixel circuit shown in FIG. 6, the reference voltage writing circuit includes a first transistor T1, the compensation control circuit includes a second transistor T2, and the on-off control circuit includes a third transistor T3; the light-emitting element is an organic light-emitting diode O1;
the gate electrode of the first transistor T1 is electrically connected to the scanning line Sc, the source electrode of the first transistor T1 is electrically connected to the reference voltage end VR, and the drain electrode of the first transistor T1 is electrically connected to the source electrode of the driving transistor DT;
the gate electrode of the second transistor T2 is electrically connected to the first gate line G1, the source electrode of the second transistor T2 is electrically connected to the control node Ct, and the drain electrode of the second transistor T2 is electrically connected to the drain electrode of the driving transistor DT;
the gate electrode of the third transistor T3 is electrically connected to the first gate line G1, the source electrode of the third transistor T3 is electrically connected to the gate electrode of the driving transistor DT, and the drain electrode of the third transistor T3 is electrically connected to the control node Ct;
the data writing circuit includes a fourth transistor T4, the first light-emitting control circuit includes a fifth transistor T5, the second light-emitting control circuit includes a sixth transistor T6, and the first initialization circuit includes a seventh transistor T7;
the gate electrode of the fourth transistor T4 is electrically connected to the second gate line G2, the source electrode of the fourth transistor T4 is electrically connected to the data line D1, and the drain electrode of the fourth transistor T4 is electrically connected to the source electrode of the driving transistor DT;
the gate electrode of the fifth transistor T5 is electrically connected to the light-emitting control line E1, the source electrode of the fifth transistor T5 is electrically connected to the power voltage end VDD, and the drain electrode of the fifth transistor T5 is electrically connected to the source electrode of the driving transistor DT;
the gate electrode of the sixth transistor T6 is electrically connected to the light-emitting control line E1, the source electrode of the sixth transistor T6 is electrically connected to the drain electrode of the driving transistor DT, and the drain electrode of the sixth transistor T6 is electrically connected to the anode of the organic light-emitting diode O1; the cathode of the O1 is electrically connected to the low voltage end VSS;
the gate electrode of the seventh transistor T7 is electrically connected to the reset line R1, the source electrode of the seventh transistor T7 is electrically connected to the first initial voltage end I1, and the drain electrode of the seventh transistor T7 is electrically connected to the control node Ct;
the energy storage circuit includes a storage capacitor Cst, and the second initialization circuit includes an eighth transistor T8;
the first end of the storage capacitor Cst is electrically connected to the gate electrode of the driving transistor DT, and the second end of the storage capacitor Cst is electrically connected to the power voltage end VDD;
the gate electrode of the eighth transistor T8 is electrically connected to the scanning line Sc, the source electrode of the eighth transistor T8 is electrically connected to the second initial voltage end I2, and the drain electrode of the eighth transistor T8 is electrically connected to the anode of the organic light-emitting diode O1.

In at least one embodiment of the pixel circuit shown in FIGS. 10, T2 and T3 are n-type transistors, and T1, T4, T5, T6, T7, T8 and DT are all p-type transistors.

In at least one embodiment of the pixel circuit shown in FIG. 10, the T2 and the T3 are oxide thin-film transistors, while the other transistors may be Low-Temperature Polycrystalline Silicon (LTPS) transistors, but the present disclosure is not limited thereto.

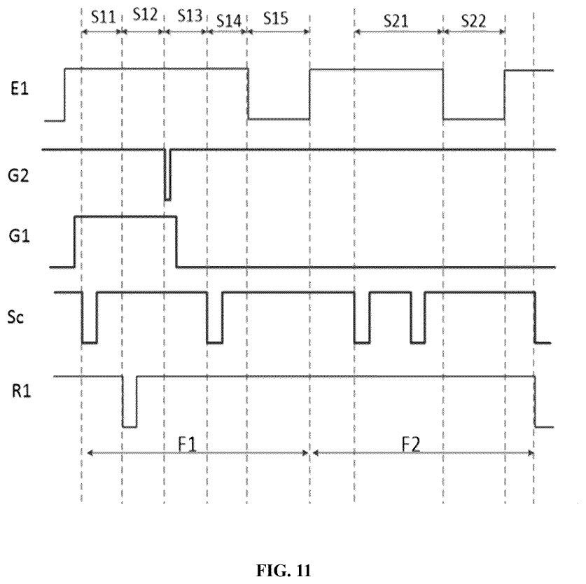

In at least one embodiment, when the pixel circuit shown in FIG. 10 of the present disclosure is in operation, as shown in FIG. 11, the display period may include a refreshing frame and a maintenance frame;
as shown in FIG. 11, the refreshing frame includes a first phase S11, a reset phase S12, a data writing phase S13, a first bias phase S14 and a first light-emitting phase S15 arranged sequentially in that order; the maintenance frame includes a second bias phase S21 and a second light-emitting phase S22 arranged sequentially in that order;
in the first time period included in the first phase S11, the Sc provides a low voltage signal, the T1 is turned on, to write the reference voltage Vref into the source electrode of the DT;
in the first phase S11, the E1 provides a high voltage signal, the G2 provides a high voltage signal, the G1 provides a high voltage signal, the R1 provides a high voltage signal, the T2 is turned on, the T3 is turned on, and the gate electrode of the driving transistor DT is electrically connected to the drain electrode of the driving transistor DT; the source electrode potential of the DT is Vref;
in the first phase S11, the DT is in the diode connection mode, the gate-source voltage Vgs of the DT is equal to Vth, the DT is in the off-bias state, and Vth is the threshold voltage of the DT;
in the second time period included in the reset phase S12, the R1 provides a low voltage signal, the T7 is turned on, to write the first initial voltage Vinit1 on the I1 into the control node Ct;
in the reset phase S12, the E1 provides a high voltage signal, the G2 provides a high voltage signal, the G1 provides a high voltage signal, the Sc provides a high voltage signal, both the T2 and the T3 are turned on, to write Vinit1 into the gate electrode of the DT, and the gate electrode of the DT is electrically connected to the drain electrode of the DT, the DT is in the diode connection mode, and the gate-source voltage Vgs of the DT is equal to Vth, the DT is in the off-bias state;
in the third time period included in the data writing phase S13, the G2 provides a low voltage signal, to write the data voltage Vdata on the data line D1 into the source electrode of the driving transistor DT;
in the fourth time period included in the data writing phase S13, the G1 provides a high voltage signal, the T3 is turned on, the T2 is turned on, to control the gate electrode of the DT to be electrically connected to the drain electrode of the DT, and to control DT to be in the diode connection mode, the gate-source voltage Vgs of the DT is equal to Vth, the gate electrode potential of the DT is Vdata+Vth, and the DT is in the off-bias state;
in the data writing phase S13, the E1 provides a high voltage signal, the Sc provides a high voltage signal, the T5 and the T6 are turned off, T1 is turned off, and T8 is turned off;

in the fifth time period included in the first bias phase S14, the Sc provides a low voltage signal, the T1 is turned on, to write the reference voltage Vref into the source electrode of the DT, the T8 is turned on, to write the second initial voltage Vinit2 on the 12 into the anode of the O1, so as to clear the residual charge on the anode of the O1;
in the first bias phase S14, the E1 provides a high voltage signal, the G2 provides a high voltage signal, the G1 provides a low voltage signal, the R1 provides a high voltage signal, the T5 and the T6 are turned off, the T1 is turned off, the T8 is turned off; the T2 is turned off, the T7 is turned off, and the gate electrode potential of the DT is maintained at Vdata+Vth;
in the first bias phase S14, the gate-source voltage Vgs of the DT is equal to Vdata+Vth−Vref, and the first bias phase S14 is a negative voltage bias phase;
in the first light-emitting phase S15, the E1 provides a low voltage signal, the G2 provides a high voltage signal, the G1 provides a low voltage signal, the Sc provides a high voltage signal, the R1 provides a high voltage signal, the T5 and the T6 are turned on, and the DT drives the O1 to emit light;
in the sixth and seventh time periods included in the second bias phase S21, the Sc provides a low voltage signal, the T1 and the T8 are turned on, to write the reference voltage Vref into the source electrode of the DT and write the second initial voltage Vinit2 into the anode of the O1;
in the second bias phase S21, the E1 provides a high voltage signal, the G2 provides a high voltage signal, the G1 provides a low voltage signal, the R1 provides a high voltage signal; the T5 and the T6 are turned off, the T1 is turned off, the T8 is turned off; the T2 is turned off, the T7 is turned off, and the gate electrode potential of the DT is maintained at Vdata+Vth;
in the second bias phase S21, the gate-source voltage Vgs of the DT is equal to Vdata+Vth−Vref, and the second bias phase S21 is a negative voltage bias phase;
in the second light-emitting phase S22, the E1 provides a low voltage signal, the G2 provides a high voltage signal, the G1 provides a low voltage signal, the Sc provides a high voltage signal, the R1 provides a high voltage signal, the T5 and the T6 are turned on, and the DT drives the O1 to emit light.

In at least one embodiment, when the pixel circuit shown in FIG. 10 of the present disclosure is in operation,
in the first phase, the reset phase S12 and the data writing phase S13 included in the refreshing frame, the DT is in the off-bias state. However, since the gate-source voltage of the DT is Vth, the threshold voltage drift of the DT is small in the S11, the S12 and the S13, and the DT is not in a strong bias state;
in the first bias phase S14 included in the refreshing frame, the gate-source voltage Vgs of DT is equal to Vdata+Vth−Vref, and the first bias phase S14 is a negative voltage bias phase;
in the second bias phase S21 included in the maintenance frame, the gate-source voltage Vgs of the DT is equal to Vdata+Vth−Vref, and the second bias phase S21 is a negative voltage bias phase.

In at least one embodiment, when the pixel circuit shown in FIG. 10 of the present disclosure is in operation, in the refreshing frame, before the data writing phase, there is no strong bias process applied to the driving transistor DT, and in the first bias phase S14 included in the refreshing frame and the second bias phase S21 included in the maintenance frame, a negative voltage bias is applied to the driving transistor DT. By arranging the bias voltage and bias time in the refreshing frame and the maintenance frame, the bias state of the driving transistor DT in the refreshing frame and the bias state of the driving transistor DT in the maintenance frame can be similar, and the threshold voltage of the driving transistor DT is roughly consistent, thereby ensuring that there is no significant difference in the light-emitting brightness of the O1 in the refreshing frame and the light-emitting brightness of the O1 in the maintenance frame, and there is no visual flicker.

In at least one embodiment of the pixel circuit shown in FIG. 10 of the present disclosure, five control signal lines are included, that are, a light-emitting control line E1, a first gate line G1, a second gate line G2, a scanning line Sc and a reset line R1. Compared with the pixel circuit shown in FIG. 8 according to at least one embodiment of the present disclosure, the pixel circuit shown in FIG. 10 according to at least one embodiment of the present disclosure reduces the compensation control line and only uses five control signal lines, which is conducive to high Pixel Per Inch (PPI) and narrow bezel design.

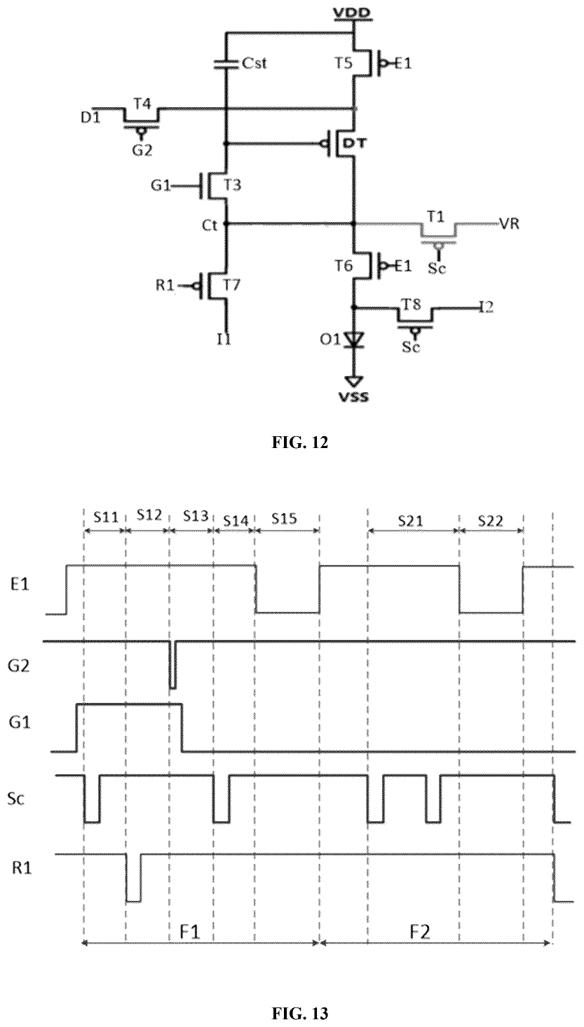

As shown in FIG. 12, based on at least one embodiment of the pixel circuit shown in FIG. 7, the reference voltage writing circuit includes a first transistor T1, the on-off control circuit includes a third transistor T3; the light-emitting element is an organic light-emitting diode O1;
the gate electrode of the first transistor T1 is electrically connected to the scanning line Sc, the source electrode of the first transistor T1 is electrically connected to the reference voltage end VR, and the drain electrode of the first transistor T1 is electrically connected to the second electrode of the driving transistor DT;
the gate electrode of the third transistor T3 is electrically connected to the first gate line G1, the source electrode of the third transistor T3 is electrically connected to the gate electrode of the driving transistor DT, and the drain electrode of the third transistor T3 is electrically connected to the second electrode of the driving transistor DT;
the data writing circuit includes a fourth transistor T4, the first light-emitting control circuit includes a fifth transistor T5, the second light-emitting control circuit includes a sixth transistor T6, and the first initialization circuit includes a seventh transistor T7;
the gate electrode of the fourth transistor T4 is electrically connected to the second gate line G2, the source electrode of the fourth transistor T4 is electrically connected to the data line D1, and the drain electrode of the fourth transistor T4 is electrically connected to the first electrode of the driving transistor DT;
the gate electrode of the fifth transistor T5 is electrically connected to the light-emitting control line E1, the source electrode of the fifth transistor T5 is electrically connected to the power voltage end VDD, and the drain electrode of the fifth transistor T5 is electrically connected to the first electrode of the driving transistor DT;
the gate electrode of the sixth transistor T6 is electrically connected to the light-emitting control line E1, the source electrode of the sixth transistor T6 is electrically connected to the second electrode of the driving transistor DT, and the drain electrode of the sixth transistor T6 is electrically connected to the anode of the organic light-emitting diode O1;
the gate electrode of the seventh transistor T7 is electrically connected to the reset line R1, and the source electrode of the seventh transistor T7 is electrically connected to the first initial voltage end I1 is electrically connected, the drain electrode of the seventh transistor T7 is electrically connected to the control node Ct;
the energy storage circuit includes a storage capacitor Cst, and the second initialization circuit includes an eighth transistor T8;
the first end of the storage capacitor Cst is electrically connected to the gate electrode of the driving transistor DT, and the second end of the storage capacitor Cst is electrically connected to the power voltage end VDD;
the gate electrode of the eighth transistor T8 is electrically connected to the scanning line Sc, the source electrode of the eighth transistor T8 is electrically connected to the second initial voltage end I2, and the drain electrode of the eighth transistor T8 is electrically connected to the anode of the organic light emitting diode O1.

In at least one embodiment of the pixel circuit shown in FIG. 12, the first electrode of the DT may be a source electrode, and the second electrode of the DT may be a drain electrode; or, the first electrode of the DT may be a drain electrode, and the second electrode of the DT may be a source electrode.

In at least one embodiment of the pixel circuit shown in FIG. 12, the T3 is an n-type transistor, and the T1, the T4, the T5, the T6, the T7, the T8 and the DT are all p-type transistors.

In at least one embodiment, when the pixel circuit shown in FIG. 12 is in operation, the display period may include a refreshing frame and a maintenance frame;
as shown in FIG. 13, the refreshing frame includes a first phase S11, a reset phase S12, a data writing phase S13, a first bias phase S14 and a first light-emitting phase S15 arranged sequentially in that order; the maintenance frame includes a second bias phase S21 and a second light-emitting phase S22 arranged sequentially in that order;
in the first time period included in the first phase S11, the Sc provides a low voltage signal, the T1 is turned on, to write the reference voltage Vref into the second electrode of the DT;
in the first phase S11, the E1 provides a high voltage signal, the G2 provides a high voltage signal, the G1 provides a high voltage signal, the R1 provides a high voltage signal, the T3 is turned on, and the gate electrode of the driving transistor DT is electrically connected to the second electrode of the driving transistor DT; the potential of the second electrode of the DT is Vref;
in the first phase S11, the DT is in a diode connection mode, the gate-source voltage Vgs of the DT is equal to Vth, the DT is in an off-bias state, and Vth is the threshold voltage of the DT;
in the second time period included in the reset phase S12, the R1 provides a low voltage signal, the T7 is turned on, to write the first initial voltage Vinit1 on the I1 into the control node Ct;
in the reset phase S12, the E1 provides a high voltage signal, the G2 provides a high voltage signal, the G1 provides a high voltage signal, the Sc provides a high voltage signal, the T3 is turned on, to write Vinit1 into the gate electrode of the DT, and the gate electrode of the DT is electrically connected to the second electrode of the driving transistor DT, the driving transistor DT is in a diode connection mode, the gate-source voltage Vgs of the driving transistor DT is equal to Vth, and the DT is in an off-bias state;
in the third time period included in the data writing phase S13, the G2 provides a low voltage signal, to write the data voltage Vdata on the data line D1 into the first electrode of the driving transistor DT;
in the fourth time period included in the data writing phase S13, the G1 provides a high voltage signal, the T3 is turned on, to control the gate electrode of the driving transistor DT to be electrically connected to the second electrode of the driving transistor DT, and to control the driving transistor DT to be the in diode connection mode, the gate-source voltage Vgs of the driving transistor DT is equal to Vth, and the gate electrode potential of the driving transistor DT is Vdata+Vth;
in the data writing phase S13, the E1 provides a high voltage signal, the Sc provides a high voltage signal, the T5 and the T6 are turned off, the T1 is turned off, and the T8 is turned off;
in the fifth time period included in the first bias phase S14, the Sc provides a low voltage signal, the T1 is turned on, to write the reference voltage Vref into the second electrode of the driving transistor DT, and the T8 is turned on, to write the second initial voltage Vinit2 on the I2 into the anode of the O1, so as to clear the residual charge on the anode of the O1;
in the first bias phase S14, the E1 provides a high voltage signal, the G2 provides a high voltage signal, the G1 provides a low voltage signal, the R1 provides a high voltage signal, the T5 and the T6 are turned off, the T1 is turned off, the T8 is turned off; the T7 is turned off, and the gate electrode potential of the driving transistor DT is maintained at Vdata+Vth;
in the first bias phase S14, the gate-source voltage Vgs of the driving transistor DT is equal to Vdata+Vth−Vref, and the first bias phase S14 is a negative voltage bias phase;
in the first light-emitting phase S15, the E1 provides a low voltage signal, the G2 provides a high voltage signal, the G1 provides a low voltage signal, the Sc provides a high voltage signal, the R1 provides a high voltage signal, the T5 and the T6 are turned on, and the DT drives the O1 to emit light;
in the sixth and seventh time periods included in the second bias phase S21, the Sc provides a low voltage signal, the T1 and the T8 are turned on, to write the reference voltage Vref into the second electrode of the DT and write the second initial voltage Vinit2 into the anode of the O1;
in the second bias phase S21, the E1 provides a high voltage signal, the G2 provides a high voltage signal, the G1 provides a low voltage signal, and the R1 provides a high voltage signal; the T5 and the T6 are turned off, the T1 is turned off, the T8 is turned off; the T7 is turned off, and the gate electrode potential of the DT is maintained at Vdata+Vth;
in the second bias phase S21, the gate-source voltage Vgs of the DT is equal to Vdata+Vth−Vref, and the second bias phase S21 is a negative voltage bias phase;
in the second light-emitting phase S22, the E1 provides a low voltage signal, the G2 provides a high voltage signal, the G1 provides a low voltage signal, the Sc provides a high voltage signal, the R1 provides a high voltage signal, the T5 and the T6 are turned on, and the DT drives the O1 to emit light.

In at least one embodiment, when the pixel circuit shown in FIG. 12 of the present disclosure is in operation,
in the first phase S11, the reset phase S12 and the data writing phase S13 included in the refreshing frame, the DT is in the off-bias state. However, since the gate-source voltage of the DT is Vth, the threshold voltage drift of the DT is small in S11, S12 and S13, and the DT is not in a strong bias state;
in the first bias phase S14 included in the refreshing frame, the gate-source voltage Vgs of the DT is equal to Vdata+Vth−Vref, and the first bias phase S14 is a negative voltage bias phase;
in the second bias phase S21 included in the maintenance frame, the gate-source voltage Vgs of the DT is equal to Vdata+Vth−Vref, and the second bias phase S21 is a negative voltage bias phase.

In at least one embodiment, when the pixel circuit shown in FIG. 12 of the present disclosure is in operation, in the refreshing frame, before the data writing phase, there is no strong bias process applied to the driving transistor DT, and in the first bias phase S14 included in the refreshing frame and the second bias phase S21 included in the maintenance frame, a negative voltage bias is applied to the driving transistor DT. By arranging the bias voltage and bias time in the refreshing frame and the maintenance frame, the bias state of the driving transistor DT in the refreshing frame and the bias state of the driving transistor DT in the maintenance frame can be similar, and the threshold voltage of the driving transistor DT is roughly consistent, thereby ensuring that there is no significant difference in the light-emitting brightness of the O1 in the refreshing frame and the light-emitting brightness of the O1 in the maintenance frame, and there is no visual flicker.

Compared with the pixel circuit shown in FIG. 10 according to at least one embodiment of the present disclosure, the pixel circuit shown in FIG. 12 according to at least one embodiment of the present disclosure reduces the use of the second transistor and only includes one oxide thin-film transistor, which is conducive to high Pixel Per Inch (PPI) and narrow bezel design.

In at least one embodiment of the pixel circuit shown in FIG. 12, the T3 is an oxide thin-film transistor, while the other transistors may be Low-Temperature Polycrystalline Silicon (LTPS) transistors, but the present disclosure is not limited thereto.

At least one embodiment of the pixel circuit shown in FIG. 8 of the present disclosure, at least one embodiment of the pixel circuit shown in FIG. 10 of the present disclosure, and at least one embodiment of the pixel circuit shown in FIG. 12 of the present disclosure can not only eliminate the influence of the strong reset bias on the characteristics of the driving transistor DT and improve flicker, but also improve a short-term residual image and a First Frame Ratio (FFR) issue caused by the hysteresis of the driving transistor DT to a certain extent. In the refreshing frame, before data is written, in the first phase, the reset phase, and the data writing phase, the driving transistor DT is in the off-bias state, which can eliminate the influence of the grayscale voltage of the previous frame on the brightness of the current frame.

The driving method according to the embodiment of the present disclosure is applied to the above-mentioned pixel circuit, wherein a display period includes the refreshing frame; the refreshing frame includes the first phase arranged before the data writing phase; the driving method includes:
in the first phase of the refreshing frame, controlling, by the control circuit, the absolute value of the difference between the potential of the gate electrode of the driving transistor and the potential of the electrode of the driving transistor to be less than the voltage difference threshold; the electrode includes the first electrode of the driving transistor and/or the second electrode of the driving transistor.

In the driving method according to the embodiment of the present disclosure, in the refreshing frame, before the data writing phase, the driving transistor will not be reset and strongly biased. This prevents the reset strong bias from affecting the characteristics of the driving transistor, which can effectively reduce or eliminate a phenomenon of uneven brightness caused by a difference between an operating state of the driving transistor in the refreshing frame and an operating state of the driving transistor in the maintenance frame, thereby inhibiting flicker.

Optionally, a ratio of the voltage difference threshold to an absolute value of a threshold voltage of the driving transistor is greater than or equal to 0.8 and less than or equal to 1.2, but the present disclosure is not limited thereto.

In at least one embodiment of the present disclosure, the control circuit includes a reference voltage writing circuit, a compensation control circuit and an on-off control circuit; the refreshing frame further includes a reset phase and the data writing phase arranged sequentially in that order after the first phase; the driving method includes:
in at least part of the first phase, the reset phase and at least part of the data writing phase, writing, by the reference voltage writing circuit, the reference voltage to the first electrode of the driving transistor under the control of a scanning signal, and controlling, by the compensation control circuit, the second electrode of the driving transistor to be electrically connected to a control node under the control of a compensation control signal; controlling, by the on-off control circuit, the gate electrode of the driving transistor to be electrically connected to the control node under the control of a first gate electrode driving signal, to cause the driving transistor to be in a diode connection state.

In at least one embodiment of the present disclosure, the control circuit includes a reference voltage writing circuit and an on-off control circuit; the refreshing frame further includes a reset phase and the data writing phase arranged sequentially in that order after the first phase; the driving method includes:
in at least part of the first phase, the reset phase and at least part of the data writing phase, writing, by the reference voltage writing circuit, the reference voltage to the second electrode of the driving transistor under the control of a scanning signal; controlling, by the on-off control circuit, the gate electrode of the driving transistor to be electrically connected to the second electrode of the driving transistor under the control of a first gate electrode driving signal, to cause the driving transistor to be in a diode connection state.

Optionally, the refreshing frame further includes a first bias phase and a first light-emitting phase arranged after the data writing phase; the pixel circuit further includes a light-emitting element, a first initialization circuit, the data writing phase, a first light-emitting control circuit and a second light-emitting control circuit;
in at least part of the data writing phase, writing, by a data writing circuit, a data voltage on a data line into the first electrode of the driving transistor under the control of a second gate electrode driving signal;
in at least part of the reset phase, writing, by the first initialization circuit, a first initial voltage into the control node under the control of a reset signal;
in at least part of the first bias phase, writing, by the reference voltage writing circuit, the reference voltage into the first electrode of the driving transistor or the second electrode of the driving transistor under the control of the scanning signal;
in the first light-emitting phase, controlling, by the first light-emitting control circuit, a first voltage end to be electrically connected to the first electrode of the driving transistor under the control of a light-emitting control signal provided by a light-emitting control line, and controlling, by the second light-emitting control circuit, the second electrode of the driving transistor to be electrically connected to a first electrode of the light-emitting element under the control of the light-emitting control signal, and driving, by the driving transistor, the light-emitting element.

In at least one embodiment of the present disclosure, the display period further includes a maintenance frame; the maintenance frame includes a second bias phase and a second light-emitting phase arranged sequentially in that order; the driving method includes:
in at least part of the second bias phase, writing, by the reference voltage writing circuit, the reference voltage into the first electrode of the driving transistor or the second electrode of the driving transistor under the control of the scanning signal;
in the second light-emitting phase, controlling, by a first light-emitting control circuit, a first voltage end to be electrically connected to the first electrode of the driving transistor under the control of a light-emitting control signal provided by a light-emitting control line, and controlling, by a second light-emitting control circuit, the second electrode of the driving transistor to be electrically connected to a first electrode of a light-emitting element under the control of the light-emitting control signal, and driving, by the driving transistor, the light-emitting element.

The display device according to the embodiments of the present disclosure includes the above-mentioned pixel circuit.

The display device provided in the embodiments of the present disclosure can be any product or component with a display function, such as a mobile phone, a tablet, a television, a monitor, a laptop, a digital photo frame, a navigator, etc.

The above are preferred embodiments of the present disclosure. It should be noted that for those of ordinary skill in the art, improvements and modifications can be made without departing from the principles described in the present disclosure, and these improvements and modifications should also be regarded as being within the scope of the present disclosure.

1. A pixel circuit, comprising a driving transistor and a control circuit;
the control circuit is electrically connected to a gate electrode of the driving transistor, and the control circuit is further electrically connected to an electrode of the driving transistor; the control circuit is configured to control, in a first phase of a refreshing frame, an absolute value of a difference between a potential of the gate electrode of the driving transistor and a potential of the electrode of the driving transistor to be less than a voltage difference threshold, wherein the first phase is arranged before a data writing phase;
the electrode comprises a first electrode of the driving transistor and/or a second electrode of the driving transistor.

2. The pixel circuit according to claim 1, wherein a ratio of the voltage difference threshold to an absolute value of a threshold voltage of the driving transistor is greater than or equal to 0.8 and less than or equal to 1.2.

3. The pixel circuit according to claim 1, wherein the control circuit comprises a reference voltage writing circuit, a compensation control circuit and an on-off control circuit;
the reference voltage writing circuit is electrically connected to each of a scanning line, a reference voltage end and the first electrode of the driving transistor, and is configured to write a reference voltage provided by the reference voltage end into the first electrode of the driving transistor under the control of a scanning signal provided by the scanning line;
the compensation control circuit is electrically connected to each of a compensation control line, the second electrode of the driving transistor and a control node, and is configured to control the second electrode of the driving transistor to be electrically connected to the control node under the control of a compensation control signal provided by the compensation control line;
the on-off control circuit is electrically connected to each of a first gate line, the gate electrode of the driving transistor and the control node, and is configured to control the gate electrode of the driving transistor to be electrically connected to the control node under the control of a first gate electrode driving signal provided by the first gate line.

4. The pixel circuit according to claim 1, wherein the control circuit comprises a reference voltage writing circuit and an on-off control circuit;
the reference voltage writing circuit is electrically connected to each of a scanning line, a reference voltage end and the second electrode of the driving transistor, and is configured to write a reference voltage provided by the reference voltage end into the second electrode of the driving transistor under the control of a scanning signal provided by the scanning line;
the on-off control circuit is electrically connected to each of a first gate line, the gate electrode of the driving transistor and the second electrode of the driving transistor, and is configured to control the gate electrode of the driving transistor to be electrically connected to the second electrode of the driving transistor under the control of a first gate electrode driving signal provided by the first gate line.

5. The pixel circuit according to claim 3, wherein the reference voltage writing circuit comprises a first transistor, the compensation control circuit comprises a second transistor, and the on-off control circuit comprises a third transistor;
a gate electrode of the first transistor is electrically connected to the scanning line, a first electrode of the first transistor is electrically connected to the reference voltage end, and a second electrode of the first transistor is electrically connected to the first electrode of the driving transistor;
a gate electrode of the second transistor is electrically connected to the compensation control line, a first electrode of the second transistor is electrically connected to the control node, and a second electrode of the second transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the control node.

6. The pixel circuit according to claim 5, wherein the second transistor is a p-type transistor; or, both the second transistor and the third transistor are n-type transistors, and the compensation control line and the first gate line are a same signal line.

7. The pixel circuit according to claim 4, wherein the reference voltage writing circuit comprises a first transistor, and the on-off control circuit comprises a third transistor;
a gate electrode of the first transistor is electrically connected to the scanning line, a first electrode of the first transistor is electrically connected to the reference voltage end, and a second electrode of the first transistor is electrically connected to the second electrode of the driving transistor;
a gate electrode of the third transistor is electrically connected to the first gate line, a first electrode of the third transistor is electrically connected to the gate electrode of the driving transistor, and a second electrode of the third transistor is electrically connected to the second electrode of the driving transistor.

8. The pixel circuit according to claim 1, further comprising a light-emitting element, a first light-emitting control circuit, a second light-emitting control circuit, a data writing circuit and a first initialization circuit;
the first light-emitting control circuit is electrically connected to each of a light-emitting control line, a first voltage end, and the first electrode of the driving transistor, and is configured to control the first voltage end to be electrically connected to the first electrode of the driving transistor under the control of a light-emitting control signal on the light-emitting control line;
the second light-emitting control circuit is electrically connected to each of the light-emitting control line, the second electrode of the driving transistor and a first electrode of the light-emitting element, and is configured to control the second electrode of the driving transistor to be electrically connected to the first electrode of the light-emitting element under the control of the light-emitting control signal provided by the light-emitting control line; a second electrode of the light-emitting element is electrically connected to a second voltage end;
the data writing circuit is electrically connected to each of a second gate line, a data line, and the first electrode of the driving transistor, and is configured to write a data voltage provided by the data line into the first electrode of the driving transistor under the control of a second gate electrode driving signal provided by the second gate line;
the first initialization circuit is electrically connected to each of a reset line, a first initial voltage end and a control node, and is configured to write a first initial voltage provided by the first initial voltage end into the control node under the control of a reset signal provided by the reset line.

9. The pixel circuit according to claim 8, further comprising an energy storage circuit;
the energy storage circuit is electrically connected to the gate electrode of the driving transistor, and is configured to maintain the potential of the gate electrode of the driving transistor.

10. The pixel circuit according to claim 9, further comprising a second initialization circuit;
the second initialization circuit is electrically connected to each of a scanning line, a second initial voltage end and the first electrode of the light-emitting element, and is configured to write a second initial voltage provided by the second initial voltage end into the first electrode of the light-emitting element under the control of a scanning signal provided by the scanning line.

11. The pixel circuit according to claim 8, wherein the data writing circuit comprises a fourth transistor, the first light-emitting control circuit comprises a fifth transistor, the second light-emitting control circuit comprises a sixth transistor, and the first initialization circuit comprises a seventh transistor;
a gate electrode of the fourth transistor is electrically connected to the second gate line, a first electrode of the fourth transistor is electrically connected to the data line, and a second electrode of the fourth transistor is electrically connected to the first electrode of the driving transistor;
a gate electrode of the fifth transistor is electrically connected to the light-emitting control line, a first electrode of the fifth transistor is electrically connected to the first voltage end, and a second electrode of the fifth transistor is electrically connected to the first electrode of the driving transistor;
a gate electrode of the sixth transistor is electrically connected to the light-emitting control line, a first electrode of the sixth transistor is electrically connected to the second electrode of the driving transistor, and a second electrode of the sixth transistor is electrically connected to the first electrode of the light-emitting element;
a control electrode of the seventh transistor is electrically connected to the reset line, a first electrode of the seventh transistor is electrically connected to the first initial voltage end, and a second electrode of the seventh transistor is electrically connected to the control node.

12. The pixel circuit according to claim 10, wherein the energy storage circuit comprises a storage capacitor, and the second initialization circuit comprises an eighth transistor;
a first end of the storage capacitor is electrically connected to the gate electrode of the driving transistor, and a second end of the storage capacitor is electrically connected to the first voltage end;
a gate electrode of the eighth transistor is electrically connected to the scanning line, a first electrode of the eighth transistor is electrically connected to the second initial voltage end, and a second electrode of the eighth transistor is electrically connected to the first electrode of the light-emitting element.

13. A driving method, applied to the pixel circuit according to claim 1, wherein a display period comprises the refreshing frame; the refreshing frame comprises the first phase arranged before the data writing phase; the driving method comprises:
in the first phase of the refreshing frame, controlling, by the control circuit, the absolute value of the difference between the potential of the gate electrode of the driving transistor and the potential of the electrode of the driving transistor to be less than the voltage difference threshold; the electrode comprises the first electrode of the driving transistor and/or the second electrode of the driving transistor.

14. The driving method according to claim 13, wherein a ratio of the voltage difference threshold to an absolute value of a threshold voltage of the driving transistor is greater than or equal to 0.8 and less than or equal to 1.2.

15. The driving method according to claim 13, wherein the control circuit comprises a reference voltage writing circuit, a compensation control circuit and an on-off control circuit; the refreshing frame further comprises a reset phase and the data writing phase arranged sequentially in that order after the first phase; the driving method comprises:
in at least part of the first phase, the reset phase and at least part of the data writing phase, writing, by the reference voltage writing circuit, the reference voltage to the first electrode of the driving transistor under the control of a scanning signal, and controlling, by the compensation control circuit, the second electrode of the driving transistor to be electrically connected to a control node under the control of a compensation control signal; controlling, by the on-off control circuit, the gate electrode of the driving transistor to be electrically connected to the control node under the control of a first gate electrode driving signal, to cause the driving transistor to be in a diode connection state.

16. The driving method according to claim 13, wherein the control circuit comprises a reference voltage writing circuit and an on-off control circuit; the refreshing frame further comprises a reset phase and the data writing phase arranged sequentially in that order after the first phase; the driving method comprises:
in at least part of the first phase, the reset phase and at least part of the data writing phase, writing, by the reference voltage writing circuit, the reference voltage to the second electrode of the driving transistor under the control of a scanning signal; controlling, by the on-off control circuit, the gate electrode of the driving transistor to be electrically connected to the second electrode of the driving transistor under the control of a first gate electrode driving signal, to cause the driving transistor to be in a diode connection state.

17. The driving method according to claim 15, wherein the refreshing frame further comprises a first bias phase and a first light-emitting phase arranged after the data writing phase; the pixel circuit further comprises a light-emitting element, a first initialization circuit, the data writing phase, a first light-emitting control circuit and a second light-emitting control circuit;
in at least part of the data writing phase, writing, by a data writing circuit, a data voltage on a data line into the first electrode of the driving transistor under the control of a second gate electrode driving signal;
in at least part of the reset phase, writing, by the first initialization circuit, a first initial voltage into the control node under the control of a reset signal;
in at least part of the first bias phase, writing, by the reference voltage writing circuit, the reference voltage into the first electrode of the driving transistor or the second electrode of the driving transistor under the control of the scanning signal;
in the first light-emitting phase, controlling, by the first light-emitting control circuit, a first voltage end to be electrically connected to the first electrode of the driving transistor under the control of a light-emitting control signal provided by a light-emitting control line, and controlling, by the second light-emitting control circuit, the second electrode of the driving transistor to be electrically connected to a first electrode of the light-emitting element under the control of the light-emitting control signal, and driving, by the driving transistor, the light-emitting element.

18. The driving method according to claim 15, wherein the display period further comprises a maintenance frame; the maintenance frame comprises a second bias phase and a second light-emitting phase arranged sequentially in that order; the driving method comprises:
in at least part of the second bias phase, writing, by the reference voltage writing circuit, the reference voltage into the first electrode of the driving transistor or the second electrode of the driving transistor under the control of the scanning signal;
in the second light-emitting phase, controlling, by a first light-emitting control circuit, a first voltage end to be electrically connected to the first electrode of the driving transistor under the control of a light-emitting control signal provided by a light-emitting control line, and controlling, by a second light-emitting control circuit, the second electrode of the driving transistor to be electrically connected to a first electrode of a light-emitting element under the control of the light-emitting control signal, and driving, by the driving transistor, the light-emitting element.

19. A display device, comprising the pixel circuit according to claim 1.

20. The display device according to claim 19, wherein a ratio of the voltage difference threshold to an absolute value of a threshold voltage of the driving transistor is greater than or equal to 0.8 and less than or equal to 1.2.
